(19) United States
(12) Patent Application Publication
(10) Pub. No.: US 2022/0002467 A1
(43) Pub. Date: Jan. 6, 2022

(54) PROCESS FOR PRODUCING POLYOXYMETHYLENE POLYMERS HAVING INTERMEDIATE CHAIN LENGTH

(71) Applicants: COVESTRO INTELLECTUAL PROPERTY GMBH & CO. KG, Leverkusen (DE); PREFERE PARAFORM GMBH & CO. KG, Mainz (DE)

(72) Inventors: Markus MEURESCH, Köln (DE); Aurel WOLF, Wülfrath (DE); Christoph GÜRTLER, Köln (DE); Annika HILL, Köln (DE); Peter SCHALKE, Mainz (DE); Maik HELLER, Bad Homburg (DE); Torsten DITTMER, Königstein (DE)

(21) Appl. No.: 17/292,606

(22) PCT Filed: Nov. 20, 2019
(86) PCT No.: PCT/EP2019/081903

§ 371 Date: May 10, 2021

(51) Int. Cl. C08G 2/08; C08G 2/06; B01J 31/12

(52) U.S. Cl. CPC C08G 2/08; B01J 31/12; C08G 2/06

(57) ABSTRACT

A process for producing polyoxymethylene polymers comprises the reaction of aqueous formaldehyde solution with an aqueous solution of a base, wherein A) a starter solution comprising formaldehyde is initially charged and B) an aqueous formaldehyde solution and a base are added to the starter solution to obtain a reaction mixture. The starter solution in step A) has a temperature of ≥40° C. to ≤46° C. and the additions of the solutions in step B) are performed at a temperature of the reaction mixture of ≥40° C. to ≤46° C. The base is an alkali metal hydroxide and/or an alkaline earth metal hydroxide and the molar ratio of formaldehyde to base is ≥55:1 to ≤90:1 based on the total amounts of formaldehyde and base employed in the process. The base in step B) is added in aqueous solution.

### CROSS-REFERENCE TO RELATED APPLICATIONS

This application is a U.S. National Phase Application under 35 U.S.C. 371 of International Application No. PCT/EP2019/081903, filed on Nov. 20, 2019, which claims the benefit of European Patent Application No. 18207740.4, filed on Nov. 22, 2018. The entire disclosures of the above applications are incorporated herein by reference.

### FIELD

The present disclosure relates to a process for preparing polyoxymethylene polymers comprising reacting aqueous formaldehyde solution with an aqueous solution of a base, wherein A) a starter solution comprising formaldehyde and a base is initially charged, and B) an aqueous formaldehyde solution and a base are simultaneously added to the starter solution to obtain a reaction mixture. The disclosure also relates to a polyoxymethylene polymer obtainable by the process according to the disclosure.

### BACKGROUND

This section provides background information related to the present disclosure which is not necessarily prior art.

When formaldehyde is reacted with alkaline compounds such as sodium hydroxide solution, potassium hydroxide solution, various amines, etc., formaldehyde may react as follows, depending on the reaction conditions:

1) First of all, it should be noted that higher-percentage formaldehyde solutions precipitate sticky water-containing paraformaldehyde when subcooled, which cannot be filtered off. As a rule of thumb, supercooling of a formaldehyde solution can be avoided if the temperature in degrees Celsius is at least equal to the level of the formaldehyde concentration in % by weight.

2) In the Cannizzaro reaction, formic acid and methanol are obtained from two molecules of formaldehyde according to 2 CH₂O→HCOOH+CH₃OH. The reaction rate increases with increasing temperature of the solution and is the reason why high-percentage solutions are not storage stable for long.

3) In the so-called “saccharification reaction”, which is technically used to detoxify solutions containing formaldehyde, the isomeric sugars sorbose and fructose are formed via the triose (glyceraldehyde). The reaction can be viewed as a polymerization over the C atoms, which comes to a halt when the sugars consisting of 6 C atoms are reached: 3 CH₂O→HOCH₂CH(OH)CHO+another 3 CH₂O sorbose and fructose. The reaction is exothermic and can therefore accelerate itself

Today, industrially produced polymeric forms of formaldehyde include short-chain polymers known as paraformaldehyde, which have a molecular mass of about 500 g/mol, and long-chain polyoxymethylene polymers (POM), which usually have a molecular mass of about 10.000 g/mol to 30.000 g/mol.

WO 2004/096746 A1 discloses starting compounds for the preparation of polyurethanes which can be prepared by reacting oligomers of formaldehyde containing hydroxyl groups. Suitable oligomers are the compounds of the formula HO—[CH₂—O]ₙ—H with n=2 to 19, preferably n=1 to 9, which can be prepared according to EP 1 063 221 A1.

WO 2015/155094 A1 relates to a process for the preparation of polyoxymethylene block copolymers by catalytic addition of alkylene oxides and optionally further comonomers to at least one polymeric formaldehyde initiator compound having at least one terminal hydroxyl group in the presence of a double metal cyanide (DMC) catalyst, wherein (i) in a first step the DMC catalyst is activated in the presence of the polymeric formaldehyde initiator compound, wherein a partial amount (based on the total amount of alkylene oxides used in the activation and polymerization) of one or more alkylene oxides is added to activate the DMC catalyst, (ii) in a second step, one or more alkylene oxides and optionally further comonomers are added to the mixture resulting from step (i), wherein the alkylene oxides used in step (ii) may be the same as or different from the alkylene oxides used in step (i), characterized in that the activation of the DMC catalyst in the first step (i) is carried out at an activation temperature (T_{act}) of 20 to 120° C.

In WO 2015/155094 A1 it is stated that suitable polymeric formaldehyde starter compounds generally have molecular weights of from 62 to 30000 g/mol, preferably from 62 to 12000 g/mol, more preferably from 242 to 6000 g/mol and most preferably from 242 to 3000 g/mol and comprise from 2 to 1000, preferably from 2 to 400, more preferably from 8 to 200 and most preferably from 8 to 100 oxymethylene repeating units. However, the preparation of the starter compounds is not described. In the embodiments, commercially available paraformaldehyde is used.

### SUMMARY

This section provides a general summary of the disclosure, and is not a comprehensive disclosure of its full scope or all of its features.

According to the disclosure, a process for the production of polyoxymethylene polymers is proposed comprising the reaction of an aqueous formaldehyde solution and an aqueous solution of a base, wherein A) a starter solution comprising formaldehyde is initially charged and B) an aqueous formaldehyde solution and a base are added to the starter solution to obtain a reaction mixture. The starter solution in step A comprises a temperature ≥40° C. to ≤46° C., the additions of the solutions in step B) are performed at a temperature of the reaction mixture of ≥40° C. to ≤46° C. The base is an alkali metal hydroxide and/or an alkaline earth metal hydroxide and the molar ratio of formaldehyde to base is ≥55:1 to ≤90:1, based on the total amounts of formaldehyde and base employed in the process. The base in step B) is added in the form of an aqueous solution.

Surprisingly, it was found that with the parameters given according to the disclosure, it is possible to obtain polyoxymethylene polymers with average chain length, that is, with a number of formaldehyde units in the polymer between that of paraformaldehyde and that of POM.

The bases in the starter solution and in step B) may be the same or different. Preferably, the bases are the same.

The use of aqueous base solution even beyond the use of alkali metal hydroxide bases has the advantage of reducing the saccharification reaction as a side reaction. In our own studies, it was observed that solid NaOH patties, which must first dissolve in the formaldehyde solution in a highly exothermic reaction, immediately initiated a saccharification reaction, which was evident from the yellow-brown color that formed around the dissolving NaOH patties. To continue to introduce as little water as possible into the reaction system, base concentrations in step B) of ≥350 g/liter to ≤700 g/liter are preferred and ≥400 g/liter to ≤600 g/liter are more preferred.

The formaldehyde solution and base solution are preferably added simultaneously in step B), for example by dropping the solutions in at the same time. Of course, the individual drops of formaldehyde solution and base do not have to arrive synchronously in the reaction mixture.

It is preferred that between the beginning of the addition of the formaldehyde solution and the beginning of the base addition in step B) there is a duration of ≤60 seconds and more preferably ≤10 seconds. It is further preferred that between the end of the addition of the formaldehyde solution and the end of the base addition in step B) there is a duration of ≤60 seconds and more preferably ≤10 seconds.

In step B), the formaldehyde solution is preferably dosed such that ≥100% by weight to ≤200% by weight (preferably ≥130% by weight to ≤150% by weight), based on the weight of the starter solution initially charged in step A), is added per hour. It is possible to select a lower dosing rate for the formaldehyde solution at the beginning of the process than towards the end. For example, the average dosing rate during the first half of the addition time in step B) may be ≥50% to ≤90% of the average dosing rate during the second half

During the polymerization reaction, the two aforementioned side reactions 2) and 3) occur, which should be suppressed as far as possible. For this purpose, the reaction should be carried out at the lowest possible temperature. On the other hand, this temperature should not be too low, because otherwise uncontrolled separation of formaldehyde from the solution occurs due to supercooling.

The lower the reaction temperature is selected, the lower the formaldehyde concentration in the solution is advantageously selected, but this in turn can lead to a significant reduction in the reaction rate with the increase in water content. The temperature range of ≥40° C. to ≤46° C. provided in accordance with the disclosure represents the compromise between the opposing requirements and only enables the polyoxymethylene polymers to be sensibly produced while largely suppressing the side reactions described above. Preferred temperatures are ≥41° C. to ≤46° C., more preferred ≥42° C. to ≤43° C. This applies both to the tempering in step A) and to the reaction mixture in step B).

Preferably, a formaldehyde concentration of about 40% in the solution is adjusted. The addition of the approximately 60% formaldehyde solution and the corresponding amount of base is preferably done as the reaction progresses and the concentration decreases so that a concentration of approximately 40% is maintained in the solution. A lower temperature such as 30° C., which would require a formaldehyde concentration of 30%, leads to uneconomically very long reaction times, although this temperature would in itself be favorable for suppressing the side reactions.

The total molar ratio of formaldehyde to base when alkali metal hydroxide bases are used is ≥55:1 to ≤90:1 and preferably ≥60:1 to ≤86:1. For other bases, for example nitrogen bases such as ammonia or hexamine decomposing to ammonia (urotropin), the total molar ratio of formaldehyde to base may be, for example, ≥25:1 to ≤100:1 and preferably ≥30:1 to ≤50:1. For multivalent bases, each proton acceptor capacity is counted individually. Of course, if a mixture of multiple bases is used, the total proton acceptor capacity of the mixture is used as the basis for calculating the molar ratio. As a concrete example, a total ratio of 76 moles of formaldehyde (calculated as 100%) to one 1 mole of NaOH (also calculated as 100%) and 86 moles of formaldehyde to one mole of KOH may serve.

Suitable reaction vessels for the process according to the disclosure are, for example, thermostated reaction vessels and preferably thermostated mixer-kneaders.

In a preferred embodiment, the starter solution is an aqueous starter solution. In the context of the present disclosure, the term “aqueous solution” means that the solution contains at least 45% by weight, based on the total weight of the solution, of water. Preferably, at least 50% by weight, more preferably at least 60% by weight.

In another preferred embodiment, the starter solution further comprises a base. The base content of the starter solution is preferably ≥0.1 wt. % to ≤5 wt. %, more preferably ≥0.3 wt. % to ≤1 wt. %.

In another preferred embodiment, the starter solution has a formaldehyde content of ≥35 wt. % to ≤50 wt.%, based on the total weight of the solution. Preferably, ≥37 wt. % to ≤45 wt. %, more preferably ≥40 wt. % to ≤42 wt. %.

In another preferred embodiment, the formaldehyde solution in step B) has a formaldehyde content of ≥50% by weight, based on the total weight of the solution. Preferably, ≥55 wt. % to ≤70 wt. %, more preferably ≥60 wt. % to ≤65 wt. %. A formaldehyde concentration as high as possible is advantageous, since if the formaldehyde content in the solution decreases, the reaction is greatly slowed down and usually comes to a standstill at about 20% formaldehyde content, as our own investigations have shown.

In another preferred embodiment, the starter solution and/or the formaldehyde solution have a methanol content of ≤1 wt. %, based on the total weight of the solution. More preferably, methanol contents of ≤0.8 wt. % and more preferably ≤0.7 wt. %. Such formaldehyde grades can be obtained from plants using the silver contact method with methanol ballast. Here, a formaldehyde solution with up to 62 wt. % formaldehyde and a methanol content of about 0.3% can be obtained. After distilling off the excess methanol, the above methanol contents can be realized.

In a further preferred embodiment, the starter solution and/or the formaldehyde solution have a formic acid content of ≤100 ppm, based on the total weight of the solution. Preferred contents are ≤50 ppm, more preferred ≤10 ppm.

Other manufacturing processes for formaldehyde, such as the metal oxide process, yield higher methanol and formic acid contents and therefore provide lower yields in the process according to the disclosure.

Furthermore, the absence of stabilizers, such as benzoguanamine, added to high-percentage formaldehyde solutions is preferred in the process according to the disclosure.

In a further preferred embodiment, the base in the starter solution and/or in step B) is an alkali metal hydroxide, an alkaline earth metal hydroxide, an amine or a mixture thereof. Examples of amines are tertiary amines such as hexamine (urotropine) or triethylamine. The inorganic bases are preferred because, compared with organic bases such as amines, they are easier to separate from the reaction product or the mother liquor by means of ion exchange resins.

Sodium hydroxide and/or potassium hydroxide are preferred in the starter solution and in step B). These bases yielded comparable purities and yields of the product in our own investigations. For example, sodium hydroxide or potassium hydroxide with concentrations of ≥400 g/liter to ≤600 g/liter can be used, especially in step B). The low-cost sodium hydroxide solution is particularly preferred.

In another preferred embodiment, the temperature of the reaction mixture is reduced after the addition of the solution of the base is completed. A post-reaction can then take place, which further increases the yield.

In another preferred embodiment, after the addition of the solution of the base is completed, the temperature of the reaction mixture is reduced to a temperature of ≥18° C. to ≤24° C. over a period of ≥3 hours to ≤6 hours.

In another preferred embodiment, the process comprises a delayed separation step to obtain a solid polyoxymethylene polymer and a mother liquor. The separation can be performed, for example, by filtration or centrifugation.

In another preferred embodiment, after the separation step, at least a portion of the mother liquor is concentrated and used as a starter solution for the reaction of the aqueous formaldehyde solution with the aqueous solution of a base.

In a further preferred embodiment, the mother liquor obtained after the separation step and/or the concentrated mother liquor is treated with acidic and/or basic ion exchange resins. Thus, bases originating from the reactants and formic acid formed during the reaction are removed.

In a further preferred embodiment, the starter solution, the formaldehyde solution and/or the solution of the base further comprise a polyol. In addition to low molecular weight polyols such as glycerol, 1,1,1-trimethylolpropane, 2-(hydroxymethyl)-2-methyl-1,3-propanediol, pentaerythritol, pentose sugars or hexose sugars, polymeric polyols such as polyether polyols or polyester polyols can also be used. Copolymers can be obtained in this way.

In another preferred embodiment, the process is carried out as a continuous process.

Specific preferred procedures for the process according to the disclosure are described below, without being limited thereto:

The reaction is started with an approx. 40-45% solution to which the required amount of sodium hydroxide solution is added according to the above given specification. Here, the starter solution temperature is 40-46° C., which is set via a cooling-heating control using a thermostat (in the laboratory). As the reaction starts, the desired solid precipitates and the formaldehyde concentration in the solution decreases. As a result, further high-percentage formaldehyde solution and the corresponding amount of caustic soda can now be added continuously, which increases the formaldehyde concentration in the solution again and keeps the caustic soda concentration in the total solution constant. The more reacting solution there is in the reactor, the more reaction takes place and the faster high-percentage formaldehyde solution and caustic soda can be added. For setting an optimum reaction time, it is therefore advantageous to know the reaction kinetics, which can be determined by measuring the formaldehyde concentration as a function of time.

The addition is completed when the reactor is completely filled. The reaction is now allowed to run down, whereby the reaction temperature should be lowered to about 20° C. in accordance with the decrease in the formaldehyde concentration in the solution. After completion of the reaction, work-up is carried out by separating the aqueous mother liquor from the solid by filtration or centrifugation. The filter cake is washed thoroughly with water to remove the caustic solution and water-soluble by-products until this runs off neutrally, and then dried, e.g., in a vacuum dryer, at a temperature of 45° C. maximum. The separated mother liquor is combined with the wash water and processed separately to recover the unreacted formaldehyde.

These operations can be realized on a larger scale by means of an apparatus consisting of a reaction vessel and a pressure suction filter with vacuum connection/distillation.

A fully continuous operation is possible by working with a stirred tank cascade. A first reactor serves as a mixing reactor in which the reaction starts. It is continued in a second reactor. This reactor also serves as a buffer for third and fourth reactors in which the reaction is completed and from which the centrifuge is fed. The reactors are preferably designed in such a way that the third reactor has just become empty when the fourth reactor becomes full, or vice versa.

The product thus obtained is obtained in a yield of up to 75% based on the amount of formaldehyde used, has a purity of 98-98.5% with respect to formaldehyde and a water content of 0.02 to 0.1%.

Since the conceivable by-products are all readily soluble in water and can therefore be easily removed during the washing process, the finding of 98-99% purity can only be explained by assuming that the sugar formed has been incorporated into the formaldehyde polymer. It is therefore a copolymer of formaldehyde and the sugars. A more detailed investigation of the propylene oxide derivative with ¹H-NMR also reveals that small amounts of methanol have also been polymerized into the formaldehyde chain.

In contrast to paraformaldehyde, which still contains 4 to 8% water depending on production and post-treatment (determination according to Karl-Fischer), only a water content normally <0.1% can be detected in this novel formaldehyde polymer using the same method. The product purity, measured by the usual formaldehyde titration method, is between 98-99%, usually around 98.5%. Consequently, the sum to 100 results from the incorporation of methanol and sugar molecules.

The yield of solid matter is 70-75%, the yield of diluted aqueous formaldehyde solution is about 12-18%, in each case based on the amount of formaldehyde used. The remaining formaldehyde is lost through the side reactions or in the wastewater. For disposal as wastewater, the wash water is mixed with lye and heated. Any formaldehyde contained in the water is saccharified in the process, so that the solution is detoxified and can be disposed of in a wastewater treatment plant.

Part of the recovered mother liquor can be returned to the emptied reactor and serves as a component of the starter solution after it has been heated to the reaction temperature and adjusted to about 40% formaldehyde concentration with high-percentage formaldehyde solution. By adding further high-percentage formaldehyde solution and further sodium hydroxide solution, the process starts again.

The processing of the mother liquor and wash water to recover the unreacted formaldehyde obtained after the separation of the solid formaldehyde polymer is possible by the following methods:

Removal of the base used and the formic acid formed by means of acidic and basic ion exchange resins. These can be regenerated by means of acid or alkali when their capacity is exhausted. In the case of processing the mother liquor by pressure distillation, it is sufficient to neutralize the mother liquor containing lye by means of an acid, e.g. HCl.

Formaldehyde solutions free of by-products can now be obtained by distillation from the solutions obtained in this way. Pressure distillation yields high-percentage formaldehyde solutions, while vacuum distillation yields low-percentage formaldehyde solutions. The resulting clean formaldehyde solutions can be used for a wide range of applications.

Distillation is not required for special applications. For example, formaldehyde solutions containing sugar are used for the production of specialty papers. For this purpose, the solution only has to be free of base.

A special case also arises if hexamine was used as base/catalyst. Ammonia or ammonium carbonate is added to the remaining aqueous formaldehyde-containing solution so that the formaldehyde component is converted to hexamine. The resulting hexamine solution can be used for silage treatment in agriculture or for the production of a bakelite resin for molding sand consolidation, which is required in cast iron production. However, since the hexamine content in the dried hexamine is below 99%, many other applications are blocked.

The disposal of aqueous waste solutions with low formaldehyde contents is done by adding sodium hydroxide solution and heating the solution to the boiling point. This converts the remaining formaldehyde components of the solution to the sugars fructose and sorbose, which caramelize at the high temperatures. The result is a brown, non-toxic solution that can be easily metabolized by the bacteria in the wastewater treatment plant.

Knowledge of the reaction rate is required for optimum design of the reactors and for carrying out the reaction. For this purpose, time-dependent samples of the reacting mixture can be taken in an experiment, the solid content removed and the formaldehyde content of the solution determined by titration. With the aid of the kinetic data obtained in this way, it is possible to calculate the required reactor sizes.

The washed polymer is dried. Vacuum drying at low temperature is best suited for this purpose. Under optimum reaction conditions, a white, free-flowing product with a yield of up to 75% is obtained, as described above. Together with the formaldehyde recovered from the mother liquor and the wash water, the total yield in terms of formaldehyde is up to 90%.

When polyols are added simultaneously to the reaction solution, formaldehyde copolymers can be produced. This addition should also be as continuous as possible to ensure a uniform composition of the solution. Suitable low molecular weight polyols include glycerol, 1,1,1-trimethylolpropane, 2-(hydroxymethyl)-2-methyl-1,3-propanediol, pentaerythritol, pentose sugars and hexose sugars, and polymeric polyols such as polyether polyols or polyester polyols can also be used. Copolymers are obtained in this way. Yield and composition of the copolymer vary depending on the type and on the amount of added polyol.

Instead of a mainly linear structure of the obtained formaldehyde polymer, these substances lead to branched-chain polymers that have different properties than the straight-chain polymers from the reactions without polyol addition.

Polymer products with a formaldehyde content of 85% up to 96% and a water content of ≤1% by weight, based on the total weight of the polymer, can thus be obtained.

The disclosure also relates to a polyoxymethylene polymer obtainable by a process according to the disclosure, having a water content of ≤1 wt. %, based on the total weight of the polymer. Preferred water contents are ≤0.1 wt. %, more preferred ≤0.05 wt. %. In the context of the present disclosure, the water content of the polyoxymethylene polymer is determined by coulometric Karl Fischer titration.

In a preferred embodiment, the polyoxymethylene polymer has an average molecular mass of ≥1100 g/mol to ≤3000 g/mol (preferably ≥1200 g/mol to ≤2500 g/mol, more preferably ≥1400 g/mol to ≤2400 g/mol). The molecular mass can be determined by ¹H and ¹³C NMR spectroscopy after derivatization with propylene oxide.

The disclosure is explained in more detail with reference to the following examples and figures, but without being limited thereto. A density of 1.524 g/ml, a mass concentration of 762.2 g NaOH and a concentration of 19.05 mol NaOH/l were used as the basis for calculating the amount of substance of the used 50% sodium hydroxide solution.

### EXAMPLE 1

A metal double jacketed vessel with approx. 12 ltr. capacity was used, which could be heated/cooled to the desired temperature by means of a thermostat. The vessel was equipped with a stirrer.

The starter solution was first prepared in this vessel. 1234 g of a low methanol aqueous formaldehyde solution containing 502 g of formaldehyde was added. To this solution, 11.6 ml of a 50% sodium hydroxide solution was added with stirring to obtain the starter solution. The reaction vessel and thus the solution were heated or cooled to 42° C. using the thermostat.

Formaldehyde solution and sodium hydroxide solution were then added at 42° C. reaction temperature. The following table lists the amount of formaldehyde and sodium hydroxide solution at the respective times that had been dosed up to that point. The figure at zero minutes corresponds to the composition of the starter solution.

| | Formaldehyde- | Calc. 100% | 50% ige |
|---|---|---|---|
| time | solution | Formaldehyde | NaOH |
| [min] | [g] | [g] | [ml] |
| 0 | 1234 | 502 | 11.6 |
| 45 | 2508 | 1279 | 29.6 |
| 80 | 4392 | 2428 | 56.3 |
| 130 | 6224 | 3603 | 83.3 |
| 215 | 8107 | 4751 | 110 |
| 260 | 10037 | 5926 | 137 |

After that, the reaction vessel was filled, the addition was stopped. A total of 197.3 mol formaldehyde and 2.6 mol NaOH were processed. This corresponds to a molar ratio of formaldehyde to base of 75.6:1.

After completion of the addition, the temperature in the double jacket vessel was started to be lowered by means of the thermostat. In about 4 hours, a temperature of about 20-22° C. was reached. After that, the reaction was allowed to continue for another 2-3 hours. Then the solution together with the precipitated solid was transferred to a suction filter with a suction flask of suitable size and sucked dry by applying a vacuum to the suction flask until nothing more dripped. The mother liquor thus obtained was removed from the suction flask and sent to vacuum distillation. The material on the suction filter was washed out with about 5 ltr. of water. The wash water must finally run off neutrally, i.e. it no longer contained any base. Afterwards, the solid was sucked dry and then dried in a dryer at low temperature (<45 ° C.) and at normal pressure to slight vacuum (approx. 200 mbar). The solid yield was up to 75.2% of the formaldehyde used, which showed a purity of 98.3% (formaldehyde titration) and a residual moisture of <0.1% (Karl-Fischer titration) in the analysis.

The mother liquor was evaporated in vacuo (boiling temperature 45° C./60-80 mbar). A 13% formaldehyde solution was obtained. The yield calculated over the solid and the recovered formaldehyde was 88.2%.

This experiment was repeated several times. The obtained samples were reacted with propylene oxide. Surprisingly, liquid products were obtained. On the basis of the evaluation of the substance consumptions as well as by the application of physical measuring methods, in particular ¹H-NMR and ¹³C-NMR, molecular masses of approx. 1400 g/mol could be determined.

### EXAMPLE 2

The same apparatus was used as in Example 1. In addition to the starter solution, a 50% sodium hydroxide solution and a high-percentage formaldehyde solution were used. The temperature in the reaction vessel was maintained at 42° C. by means of the thermostat. The following table lists the amount of formaldehyde and sodium hydroxide solution at the respective times that had been dosed up to that point. The figure at zero minutes corresponds to the composition of the starter solution.

| | Formaldehyde- | Calc. 100% | 50% ige |
|---|---|---|---|
| time | solution | Formaldehyde | NaOH |
| [min] | [g] | [g] | [ml] |
| 0 | 1223 | 533 | 12.4 |
| 40 | 2487 | 1304 | 30.4 |
| 84 | 4370 | 2452 | 57.1 |
| 120 | 6263 | 3606 | 83.9 |
| 180 | 8217 | 4797 | 112 |
| 270 | 10757 | 6346 | 148 |

A total of 211.3 mol formaldehyde and 2.8 mol NaOH were processed. This corresponds to a molar ratio of formaldehyde to base of 75.0:1.

After completion of the addition, the temperature was lowered to 20° C. for 4 hours using the thermostat. After a further 5 hours post-reaction time, the work-up was carried out by means of a suction flask. After separating the mother liquor and washing out the solid cake on the suction filter and then drying the product, the following were obtained:

4710 g of solid=74.2% with respect to formaldehyde with a purity of 98.5% and a water content of <0.1% and 3470 g of mother liquor with a formaldehyde content of 21.7%=753 g of formaldehyde or 11.8% of the original formaldehyde amount. 5900 g of wash water contained a further 8.5% formaldehyde=502 g formaldehyde. Thus, the fate of 94% of the formaldehyde used was detectable. 6% of the used formaldehyde was converted to formic acid and methanol by the Cannizzaro reaction and to sorbose and fructose by the saccharification reaction.

The mother liquor could be freed from both caustic soda and formic acid by means of ion exchange resins. First, the sodium hydroxide solution was removed. A strongly acidic ion exchange resin was used for this purpose. After passing through the resin, an acidic reacting solution was obtained in which a formic acid content of 1.3% was determined by acid titration. From this, a conversion of about 3% of the formaldehyde used, corresponding to the Cannizzaro reaction to formic acid and methanol, is calculated. Likewise, a further 3% of the formaldehyde used must have reacted to form sorbose and fructose, since 94% of the formaldehyde is in the form of polymer and aqueous solution.

The formic acid was also removed by means of a strongly basic ion exchange resin, resulting in a neutral solution. This could be used for the production of so-called “impregnating resins” for the manufacture of specialty papers by adding the solution according to the formulations applicable there. To reduce the formaldehyde content in the wash water and to increase the amount of mother liquor, provision could be made to dry the moist filter cake in an industrial-scale plant by applying a good vacuum by means of a water ring pump before the washing process was initiated.

The conclusion of this experiment is that a different molar mass of the products was obtained by the different formaldehyde concentration than in Example 1 (determined by propoxylation to about 2000 g/mol).

### EXAMPLE 3

The test was carried out as in Example 1. In addition, 1 g of 1,1,1-trimethylolpropane was added to each 30 g of formaldehyde (calculated as 100%). The TMP was added proportionally to the starter solution. A total of 6014 g formaldehyde in the form of a 60.8% aqueous solution, 155 ml of a 50% sodium hydroxide solution and 200 g 1,1,1-trimethylolpropane were added to the reaction vessel at 42° C. within 5.3 hours.

200.3 mol formaldehyde and 3.0 mol NaOH were processed. This corresponds to a molar ratio of formaldehyde to base of 67.8:1.

After the end of the reaction, the solution was filtered to isolate the solid. After washing out the adherent solution and drying the solid, 3392 g of a polymeric formaldehyde was obtained corresponding to a yield of 54.6% based on the sum of formaldehyde 100% and 1,1,1-trimethylolpropane. The formaldehyde content of the solid was 95.4% and the residual moisture was 0.04%. These analytical results demonstrate that the 1,1,1-trimethylolpropane was incorporated into the polymer chain of the formaldehyde. Consequently, this polymer chain is no longer straight but branched. The mother liquor contained 23.8% formaldehyde.

### EXAMPLE 4

The test was carried out as in Example 1. In addition, 1 g of 1,1,1-trimethylolpropane was added to each 13.3 g of formaldehyde (100%). The TMP was added proportionally to the starter solution. A total of 5777 g of formaldehyde in the form of a 61.1% aqueous solution, 135 ml of a 50% sodium hydroxide solution and 432 g of 1,1,1-trimethylolpropane were added to the reaction vessel at 42° C. within 5 hours. Thus, 192.4 moles of formaldehyde and 2.6 moles of NaOH were processed. This corresponds to a molar ratio of formaldehyde to base of 74.8:1.

After the end of the reaction, the solution was filtered to isolate the solid. After washing out the adherent solution and drying the solid, 3643 g of a polymeric formaldehyde was obtained corresponding to a yield of 56.4% based on the sum of formaldehyde 100% and 1,1,1-trimethylolpropane. The formaldehyde content of the solid was 92.3% and the residual moisture was 0.2%. These analytical results demonstrate that the 1,1,1-trimethylolpropane was incorporated into the polymer chain of the formaldehyde. Consequently, this polymer chain is no longer straight but branched, and more so than in Example 3.

### EXAMPLE 5 (COMPARISON EXAMPLE): REACTION AT 33° C. AND A 34% FORMALDEHYDE SOLUTION

A starter solution containing a 34% formaldehyde solution and sodium hydroxide solution was added. The molar ratios to each other were the same as in Example 1. The temperature of the solution was set to 33° C. and the addition of further formaldehyde solution and aqueous sodium hydroxide solution was also carried out at this temperature. Samples were titrated for formaldehyde content by removing small amounts of liquid and separating any solid material formed by filtration. The rate of addition of the two components to the mixture was chosen so that the formaldehyde content did not rise appreciably above 30%. The purpose of this measure was to avoid supercooling of the added high-percentage formaldehyde solution and thus uncontrolled precipitation of sticky paraformaldehyde.

The reaction rate decreased to about 40% compared to working at 42° C. with an approximately 40% formaldehyde solution, so that the reaction time increased by 2.5 times. A total of 4333 g of formaldehyde (calculated as 100%) and 101 ml of a 50% sodium hydroxide solution were dosed. 2903 g of solid were obtained, corresponding to a yield of 67% formaldehyde. The purity was 98.1% and the residual moisture was 0.1%. Because of the total duration of the experiment of more than 14 hours and the poorer yield, this method of operation was not pursued further. A higher purity compared to the product from Example 1 could also not be determined.

### EXAMPLE 6 (COMPARISON EXAMPLE): REACTION AT 55° C. AND A 60.1% FORMALDEHYDE SOLUTION

The experiment was carried out in the same way as in Example 1, but with a 60.1% formaldehyde solution and at 55° C. The solution was then used for the test. The amount of caustic solution was selected as in example 1. The solution turned yellowish shortly after the start of the reaction. The reaction rate—measured by titration of the formaldehyde concentration in the solution—was about 1.5 times faster than in experiment 1, so the dosing rate was increased accordingly. After the addition of 5342 g formaldehyde (100%) and 126 ml of a 50% sodium hydroxide solution, the precipitated solid was filtered off and dried. 2243 g of solid was obtained, corresponding to a yield of 41.9%. The mother liquor was clearly yellowish in color. The purity was 96.2%, the residual moisture 0.2%. Consequently, this test result is significantly worse than the result from Example 1.

### EXAMPLE 7 (COMPARISON EXAMPLE): REACTION AT 42° C. AND HIGHER SODIUM HYDROXIDE AMOUNT IN COMPARISON TO EXAMPLE 1

The experiment was carried out as in Example 1. The formaldehyde solution used had a content of 62.0%. 5337 g formaldehyde (100%) were dosed and 173 ml of a 50% sodium hydroxide solution. 3929 g of solid were obtained, corresponding to a yield of 64.6%. 177.7 mol of formaldehyde and 3.3 mol of NaOH were processed. This corresponds to a molar ratio of formaldehyde to base 53.9:1.

The purity was 99.0%, the residual moisture 0.07%. Conclusion: Increasing the amount of sodium hydroxide leads to a worse yield than in example 1.

### EXAMPLE 8 (COMPARISON EXAMPLE): REACTION AT 42° C. AND LOWER SODIUM HYDROXIDE AMOUNT IN COMPARISON TO EXAMPLE 1

The experiment was carried out as in Example 1. The formaldehyde solution used had a content of 61.0%. 5858 g formaldehyde (100%) were dosed and 110.9 ml of a 50% sodium hydroxide solution. 4081 g of solid were obtained corresponding to a yield of 69.7% based on formaldehyde. 195.1 mol of formaldehyde and 2.1 mol of NaOH were processed. This corresponds to a molar ratio of formaldehyde to base of 92.3:1.

The purity was 98.8%, the residual moisture 0.05%. Conclusion: Reducing the amount of sodium hydroxide leads to a poorer yield than in example 1.

Further areas of applicability will become apparent from the description provided herein. The description and specific examples in this summary are intended for purposes of illustration only and are not intended to limit the scope of the present disclosure.

1. A process for producing polyoxymethylene polymers, comprising the reaction of an aqueous formaldehyde solution and an aqueous solution of a base,
wherein
A) a starter solution comprising formaldehyde is initially charged and
B) an aqueous formaldehyde solution and a base are added to the starter solution to obtain a reaction mixture,
wherein the starter solution in step A comprises a temperature ≥40° C. to ≤46° C.,
the additions of the solutions in step B) are performed at a temperature of the reaction mixture of ≥40° C. to ≤46° C. and
the base is an alkali metal hydroxide and/or an alkaline earth metal hydroxide, wherein:
the molar ratio of formaldehyde to base is ≥55:1 to ≤90:1, based on the total amounts of formaldehyde and base employed in the process, and
the base in step B) is added in the form of an aqueous solution.

2. The process according to claim 1, wherein the starter solution is an aqueous starter solution.

3. The process according to claim 1, wherein the starter solution further comprises a base.

4. The process according to claim 1, wherein the starter solution comprises a formaldehyde content from ≥35 weight-% up to ≤50 weight-%, in relation to the total weight of the solution.

5. The process according to claim 1, wherein the formaldehyde solution in step B) comprises a formaldehyde content of ≥50 weight-%, in relation to the total weight of the solution.

6. The process according to claim 1, wherein the starter solution and/or the formaldehyde solution in step B) comprise a methanol content of ≤1 weight-%, in relation to the total weight of the solution.

7. The process according to claim 1, wherein the temperature of the reaction mixture is decreased after the addition of the base solution is finished.

8. The process according to claim 1, wherein the process further comprises a delayed separation step, wherein a solid polyoxymethylene polymer and a mother liquor is obtained.

9. The process according to claim 8, wherein after the separation step at least a fraction of the mother liquor is concentrated and is used as starter solution in the reaction of the aqueous formaldehyde solution and the aqueous solution of the base.

10. The process according to claim 8, wherein the mother liquor obtained after the separation step and/or the concentrated mother liquor are treated with acidic and/or basic ion exchange resins.

11. The process according to claim 1, wherein the starter solution, the formaldehyde solution and/or the solution of the base additionally comprise a polyol.

12. The process according to claim 1, wherein the process is a continuous process.

13. A polyoxymethylene-polymer, obtainable by a process according to 1, comprising a water content of ≤1 weight-%, in relation to the total weight of the polymer.

14. The polyoxymethylene-polymer according to claim 13 comprising an average molecular weight from ≥1100 g/mol up to ≤3000 g/mol.
